(19) United States
(12) Patent Application Publication
(10) Pub. No.: US 2008/0241247 A1
(43) Pub. Date: Oct. 2, 2008

(54) Compositions and Methods To Control the Growth Of Microorganisms In Aqueous Systems

(75) Inventors: Deborah A. Marais, Lakeland, TN (US); Graciela H. Vunk, Como, MS (US)

Correspondence Address: KILYK & BOWERSOX, P.L.L.C., 400 HOLIDAY COURT, SUITE 102, WARRENTON, VA, 20186, US

(73) Assignee: BUCKMAN LABORATORIES INTERNATIONAL, INC., Memphis, TN (US)

(21) Appl. No.: 12/055,718

(22) Filed: Mar. 26, 2008

Related U.S. Application Data
(60) Provisional application No. 60/920,271, filed on Mar. 27, 2007.

(51) Int. Cl. A01N 25/00; A01N 63/00; A01N 59/16; A01N 59/20; A01P 13/00

(52) U.S. Cl. 424/486; 424/94.1; 424/618; 424/630; 424/641

(57) ABSTRACT

Compositions and methods for killing, preventing, or inhibiting the growth of microorganisms in an aqueous system or other systems are provided. The compositions can include at least one first cross-linkable polymer, at least one second cross-linkable polymer, and at least one cross-linking agent, wherein the water solubilities of each cross-linking polymer are different, such as by 10% to 100%. The compositions can further include at least one biocidal component. The compositions can be formulated to slowly release the biocidal component and/or the cross-linkable polymer, or rapidly release the biocidal component and slowly release the cross-linkable polymer. The compositions can be used to control algae.

### FIELD OF THE INVENTION

This application claims the benefit under 35 U.S.C. §119(e) of prior U.S. Provisional Patent Application No. 60/920,271, filed Mar. 27, 2007, which is incorporated in its entirety by reference herein.

The present invention relates to compositions and methods to control the growth of microorganisms in aqueous systems. More particularly, the present invention relates to the treatment of aqueous systems with cross-linkable polymers having different water solubities.

### BACKGROUND OF THE INVENTION

Biological fouling is a persistent nuisance or problem in all varieties of aqueous systems. Biological fouling can have a direct adverse economic impact when it occurs in industrial process waters, for example in cooling waters, metal working fluids, or other re-circulating water systems, such as those used in papermaking or textile manufacture. If not controlled, biological fouling of industrial process waters can interfere with process operations, lowering process efficiency, wasting energy, plugging the water-handling system, and even degrading product quality.

Also, biological fouling of recreational water systems, such as pools, spas, or decorative (or ornamental) water systems (e.g., ponds or fountains), can severely detract from people's enjoyment of them. Biological fouling often results in objectionable odors. More importantly, particularly in recreational waters, biological fouling can degrade the water quality to such an extent that it becomes unfit for use and may even pose a health risk.

Sanitation waters, like industrial process waters and recreational waters, are also vulnerable to biological fouling and its associated problems. Sanitation waters include, for example, toilet water, cistern water, and sewage treatment waters. Due to the nature of the waste contained in sanitation waters, these water systems are particularly susceptible to biological fouling.

A variety of materials have been used to control algae in different environments, such as, but not exclusive to: chlorine/bromine based compounds, biguanides, copper salts, silver-based compounds, triazines, quaternary ammonium compounds and polymeric compounds. Each of them has deficiencies related to pH and/or temperature sensitivity, chemical stability and/or compatibility, limited effectiveness, and environmental and/or human toxicity.

For example, chlorine is the sanitizer/disinfectant/oxidizer most widely used by pool owners. It can be very effective at killing bacteria, algae, and other living organisms. Chlorine is typically added to a swimming pool in tablet or liquid form or is provided by a chlorine generator, which is a device containing electrical cells that generate chlorine from a bank of salt added to the pool water.

However, chlorine has many disadvantages that lessen its desirability for use as an exclusive disinfectant, for instance, in swimming pools and other recreational water systems. For example, chlorine can combine with ammonia to form chloramines, which are ineffective at sanitizing, disinfecting, or oxidizing. Ammonia is commonly present in pool water from either environmental factors, a build up of fertilizers that are carried by wind and dropped into pools, from swimmer wastes (perspiration, urine, saliva and body oils), or even from some suntan lotions. As a consequence, pool managers often over-chlorinate a pool (>3 ppm) to compensate for the transformation of chlorine into chloramines. Over-chlorination can lead to excessive absorption of chlorine and chloramines through the skin or to inhalation of air or water vapor containing chlorine and chloramines. Athletes who train for many hours in a swimming pool, particularly in an indoor environment, may be particularly susceptible to over-exposure to chlorine and chloramines and may exhibit symptoms of hypersensitivity and asthma-like respiratory conditions.

Moreover, chlorine is unsuitable for aquaculture environments that may contain desirable plants and animals that may be harmed by chlorine or its byproducts. Examples of such environments include aquariums, fish hatcheries, shrimp ponds, crawfish farms, and the like.

Ionene polymers, or polymeric quaternary ammonium compounds (polyquats), have been used to control or prevent certain biological fouling, including biofilm and slime formation, in aqueous systems. Advantageously, ionene polymers generally do not foam excessively in water or aqueous systems, do not irritate skin, and exhibit extremely low toxicity to warm-blooded animals. However, one of the drawbacks of ionene polymers is that they attach to dirt and debris found in pools, reducing their strength. This can be combated by brushing the pool, stirring up the dirt and debris, as well as the algae, and sending them to the filter for removal from the pool. It can also be combated by adding slightly more than the recommended amount of the polymeric algicide in order to compensate for any dirt or debris that still may be present. Additionally, these polymers are also slow killers and fairly ineffective at killing mustard algae or black algae, requiring chlorine (or its alternative) to complete the treatment.

Ionene polymers are commonly sold and used as liquid compositions such as aqueous solutions or formulations. Solid forms, including tablets, of ionene polymers have been described in U.S. Pat. Nos. 5,142,002 and 5,419,897. Other water treatment chemicals are often sold in solid forms, such as tablets or pucks. The following patents describe various solid forms of water treatment chemicals for use in a number of different aqueous systems: U.S. Pat. Nos. 4,310,434, 4,396,522, 4,477,363, 4,654,341, 4,683,072, 4,820,449, 4,876,003, 4,911,858, 4,961,872, and 5,205,955 as well as U.K. Patent No. 1,601,123, PCT Application WO 91/18510, PCT Application WO 92/13528, and European Patent Application No. 0 525 437 A1.

Metals such as silver or copper have been used as sanitizers and algicides. However, they have two drawbacks. They do not oxide waste and they stain pool surfaces if not used properly. Over time, copper and silver salts will accumulate on pool or spa surfaces and form blue or green stains. Combined with chlorine and sunlight, they may form gray or black stains.

Different methods for incorporating metal ions into the water have been used, including zeolite or a polymeric substance to hold the metallic ions (U.S. Pat. No. 6,217,780), but metal ion separate rather easily from the supports. This is why the textile industry use nano-particles attached or adhered to the fibers. U.S. Pat. No. 6,979,491 describes antimicrobial yarn containing nanosilver particles in the diameter of about 1 -100 nm adhered to fibers of yarn. Each nanosilver particle comprises a metallic silver core surrounded by silver oxide.

Accordingly, it is desirable to have a method of preventing, killing, and/or inhibiting the growth of microorganisms that overcomes all of the problems described above.

It is also desirable to have a method of preventing, killing, and/or inhibiting the growth of microorganisms using a composition that does not render it ineffective when the composition is combined with another composition, that is consistently effective over a long period of time, that does not damage the environment or the water system, and/or is effective to kill algae such as mustard algae or black algae.

### SUMMARY OF THE INVENTION

It has now been found that effective antimicrobial compositions to control growth of microorganisms, for example algae, in aqueous systems may be obtained by providing a composition comprising two or more cross-linkable polymers having different water solubilities. The present invention can be applied in a variety of fluid systems (e.g., aqueous systems) and processes, including but not limited to, agricultural areas (e.g., fields, hydroponics, nutrient solutions, rice patties, wet fields, or wet growing areas), cooling water systems (cooling towers, intake cooling waters and effluent cooling waters), waste water systems, recirculating water systems, hot tubs, swimming pools, recreational water systems, food processing systems, drinking water systems, and/or other industrial water systems.

In various embodiments of the present invention, the compositions can include a slow release material that will replenish the quaternary ammonium compound used for an algicide, and/or cut the need for chlorine use due to the incorporation of a biocidal component, such as nanosilver particles. The compositions can optionally act synergistically based on the different components of the compositions, or with other different compositions, to control growth of microorganisms, for example, black and mustard algae.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

It is to be understood that both the foregoing general description and the following detailed description are exemplary only and are not restrictive of the present invention, as claimed. All patents, patent applications, and publications mentioned above and throughout the present application are incorporated in their entirety by reference herein.

### DETAILED DESCRIPTION OF THE PRESENT INVENTION

The present invention provides compositions and methods for controlling the growth of microorganisms, in aqueous systems using two or more cross-linkable polymers having different water solubilities.

According to various embodiments, a composition can be prepared by combining two or more cross-linkable polymers of different water solubility in a polymer matrix, and at least one cross-linking agent, where the less water soluble polymer(s) can be algae control agents. The resulting polymer matrix or formulation can release the algae control agents over a period of time ranging from a few hours to several days to a year or more. Additional antimicrobial effects can be derived from other optional biocidal components, such as nanosilver particles entrapped in the matrix. The less water soluble polymers eventually dissolve, at a much slower rate, and can help clarify the water.

In one or more embodiments of the present invention, the composition of the present invention can be a solid material of any size. For instance, in one or more embodiments of the present invention, the product formed in the present invention can be solidified into a rigid mass of any size. The formation of the solid product can be achieved by taking the mixture of ingredients, which can be in the form of a paste, which can then be poured or otherwise placed in a mold of any shape or size and then dried to form the solid product. The shape and size, for instance, can range from a powder, or a tablet, for instance, weighing one gram, to a solid that weighs 450 grams or more, such as 750 grams, 1,000 grams, or higher. The solid product can range in weight from ½ gram, for instance, to 500 grams, from 5 grams to 300 grams, from 50 grams to 200 grams, and any ranges in between or above or below these amounts. The shape of the solid product can be a pellet, cylindrical, rectangular, or any geometrical shape. For instance, the shape can be the size and dimensions of a hockey puck. Generally, the larger the shape (or the higher the weight of the solid material), the longer time-wise the solid can release algae or other control agents over a period of time. Thus, the time release qualities of the solid mass can be dependent, in part, on the shape of the solid mass. Thus, if long-term release is desired, it would be an advantage to use large solid materials of the present invention, such as in the form of hockey pucks, which can then be dispersed throughout the area of treatment and thereby achieve immediate and long-term control of algae or other microorganisms.

As one option, in one or more embodiments of the present invention, the cross-linkable polymers, whether the first and/or second cross-linkable polymer, does not mean that cross-linking must occur, only that the polymer may be capable of cross-linking. In one or more embodiments of the present invention, the first cross-linkable polymer does not cross-link at all in the resulting polymer matrix or formulation and, instead, the first cross-linkable polymer is trapped or otherwise present in the resulting polymer matrix or formulation of the present invention. In one or more embodiments of the present invention, the second cross-linkable polymer cross-links, along with the cross-linking agent(s), alone or with other components that may be present. Thus, the first cross-linkable polymer or other material may be entrapped, embedded, or otherwise contained within the resulting polymer or matrix or formulation without being cross-linked to any material.

According to the methods of using the compositions of the present invention, controlling or inhibiting the growth of at least one microorganism includes the reduction and/or the prevention of such growth

It is to be further understood that by “controlling” (e.g., preventing) the growth of at least one microorganism, the growth of the microorganism is at least partially inhibited. In other words, there is no growth or essentially no growth of the microorganism. “Controlling” the growth of at least one microorganism maintains the microorganism population at a desired level, reduces the population to a desired level (even to undetectable limits), and/or at least partially inhibits the growth of the microorganism. Thus, in one embodiment of the present invention, the products, material, or media susceptible to attack by the at least one microorganism are at least partially preserved from this attack and the resulting spoilage and other detrimental effects caused by the microorganism. Further, it is also to be understood that “controlling” the growth of at least one microorganism also includes bio-statically reducing and/or maintaining a low level of at least one microorganism such that the attack by the microorganism and any resulting spoilage or other detrimental effects are mitigated, i.e., the microorganism growth rate or microorganism attack rate is slowed down and/or eliminated. The compositions of the present invention, however, preferably have a low toxicity to humans and higher organisms.

As used herein, the term “aqueous system” includes recreational water systems, particularly recirculating water systems such as hot tubs, spas and swimming pools and industrial fluid systems, including but not limited to, paper-making water systems, pulp slurries, white water in paper-making processes, lakes, ponds, water features (ornamental, decorative water-features, fountains, waterfalls), cooling water systems (cooling towers, intake cooling waters and effluent cooling waters), waste water systems, food processing systems, drinking water systems, leather-processing water systems, metal working fluids, and other industrial water systems. Other systems include agricultural uses, such as hydroponics uses, rice patties, nutrient solutions, wet growing areas, or wet fields.

The term “biocidal component” as used herein includes microbicides, bactericides, algicides, and the like, or any compositions that are used to combat/control (such as killing, preventing or inhibiting) undesirable microorganisms, bacteria, algae, insects, pests, or the like, or one or more organisms that are needed to be controlled as described below.

According to various embodiments, compositions for treating water are provided, comprising a cross-linkable (or cross-linked) matrix comprising at least one first cross-linkable polymer that is more water soluble (than the second cross-linkable polymer), at least one second cross-linkable polymer that is less water soluble (than the first cross-linkable polymer), and at least one cross-linking agent. The compositions can include at least one biocidal component that is different than the first cross-linkable polymer. Optionally, the biocidal component and/or the first cross-linkable polymer is at least one microbicide, at least one bactericide, and/or at least one algicide. Preferably, the biocidal component and/or the first cross-linkable polymer is an algicide.

The first cross-linkable polymers suitable for forming the matrix of the compositions according to the present invention can include generally polymers that solubilize in water relatively quickly (when compared to the second cross-linkable polymer), contain amine moieties when dissolved in water, and/or form a solid when combined with biocidal components such as, silver, copper, or zinc ion sources. Desirably, these polymers will not exhibit substantial expansion or shrinkage when combined with the above ion sources or other components and/or when dried to form a solid. When used in a cross-linkable polymer matrix for the composition, the first cross-linkable polymer can serve to clarify water and/or release a biocidal component over time. For instance, the first cross-linkable polymer can be formulated for the cross-linkable matrix to rapidly release the first cross-linkable polymer and/or the biocidal component over a period of time ranging from a few hours to several days, to even a year or more. For example, the release rate can be from about 1 hour to 7 days, 7 days to 4 to 6 weeks, 4 to 6 weeks to 4 to 6 months, 4 to 6 months to 1 year or more, or 2 to 3 days to 1 year or more than one year. The release rate of the first cross-linkable polymer can be at least faster than that of the second cross-linkable polymer.

Preferably, the water solubility of the first cross-linkable polymer is from about 80% to about 100%, wherein the percent is based on weight of polymer. The water solubility between the first cross-linkable polymer and the second cross-linkable polymer can be at least 10% different, such as from about 10% to 100%, or 25% to 75%.

Preferably, the amount or degree of cross-linkng of the first cross-linkable polymer is from about 50% to about 100%, or 75% to 100%, or 85% to 100%, or the like. The cross-linking percent refers to available sites that can cross-link.

The first cross-linking polymer can be present in the overall composition or formulation in any amount, such as from about 2% to about 80% by weight %, or from about 4% to about 24% by weight based on the total weight of the composition. Modifications as to the amount, however, can be made depending on the desirability of the different release rates of different components in the composition. For example, the monomers or cross-linkable polymers can be added in an amount ranging from about 7% to about 13% by weight, more particularly from about 8% to about 11% by weight, based on the total weight of the composition.

Preferably, the average molecular weight of the first cross-linkable polymer is from about 1,000 to about 500,000 Daltons, such as from about 1,000 to 400,000 Daltons; 1,000 to 250,000 Daltons; 1,000 to 150,000 Daltons; 1,000 to 75,000 Daltons; 1,000 to 40,000 Daltons; 1,000 to 20,000 Daltons, and the like.

According to various embodiments, the first cross-linking polymer comprises an ionene polymer or a polymeric quaternary ammonium compound. As described herein, the presence of at least one more water soluble polymer or faster release material such as a quaternary ammonium compound (when in a polymeric form, also known as an ionene polymer; these terms are used interchangeably herein) can further enhance the antimicrobial activity (such as anti-algal activity) when used with a separate biocidal component. Since the quaternary ammonium compound can be an effective biocidal composition, it can be used as a biocidal agent alone for the compositions according to the present invention.

For example, quaternary ammonium compounds, such as alkyl dimethyl benzyl ammonium chloride are commercially available as algicides. The use of a quaternary ammonium compound may provide a broader spectrum of anti-algal activity or may provide increased efficacy against problematic algae. For instance, a separate biocidal component(s) and a more water soluble polymer or faster release material such as a quaternary ammonium compound, can act synergistically to provide a particularly useful and economical antimicrobial system.

Polymeric quaternary ammonium compounds can be used and are also known as polyquats or ionene polymers. These terms are synonymous and are used interchangeably herein. They are cationic polymers containing quaternary nitrogens in the polymer backbone. Any ionene polymer or mixture of ionene polymers can be used according to the present invention. Ionene polymers can be classified according to the repeating unit found in the polymer. The repeating unit results from the reactants used to make the ionene polymer. The biological activity of this class of polymers is also known. See, e.g., A. Rembaum, Biological Activity of Ionene Polymers, Applied Polymer Symposium No. 22, 299-317 (1973) and O. May, “Polymeric Antimicrobial Agents” in Disinfection, Sterilization, and Preservation, S. Block, Ed., 322-333 (Lea & Febiger, Philadelphia, 1991).

The ionene polymer or quaternary ammonium compound that may be used to provide additional synergistic antimicrobial effects and release effects according to the present invention may be obtained from any ammonium source. For example, the quaternary ammonium compound may be a compound with a single quaternary ammonium group or a polyquaternary ammonium compound. Examples of suitable quaternary ammonium compounds include for example, N,N-diethyl-N-dodecyl-N-benzylammonium chloride, N,N-dimethyl-N-octadecyl-N-(dimethylbenzyl)ammonium chloride, N,N-dimethyl-N,N-didecylammonium chloride, N,N-dimethyl-N,N-didodecylammonium chloride, N,N,N-trimethyl-N-tetradecylammonium chloride, N-benzyl-N,N-dimethyl-N—(C₁₂-C₁₈ alkyl) ammonium chloride, N-(dichlorobenzyl)-N,-N-dimethyl-N-dodecylammonium chloride, N-hexadecylpyridinium chloride, N-hexadecylpyridinium bromide, N-hexadecyl-N,N,N-trimethylammonium bromide, N-dodecylpyridinium chloride, N-dodecylpyridinium bisulphate, N-benzyl-N-dodecyl-N,N-bis(beta-hydroxy-ethyl)ammonium chloride, N-dodecyl-N-benzyl-N,N-dimethylammonium chloride, N-benzyl-N,N-dimethyl-N—(C₁₂₋C₁₈ alkyl) ammonium chloride, N-dodecyl-N,N-dimethyl-N-ethylammonium ethylsulfate, N-dodecyl-N,N-dimethyl-N-(1-naphthylmethyl)ammonium chloride, N-hexadecyl-N,N-dimethyl-N-benzylammonium chloride or N-dodecyl-N,N-dimethyl-N-benzylammonium chloride. The quaternary ammonium compound may also be a polyquaternary ammonium compound. Antimicrobial polyquaternary ammonium compounds which may be used include those described in U.S. Pat. Nos. 3,874,870, 3,931,319, 4,027,020, 4,089,977, 4,111,679, 4,506,081, 4,581,058, 4,778,813, 4,970,211, 5,051,124, 5,093,078, 5,142,002 and 5,128,100 which are incorporated herein by reference thereto. An example of a polyquaternary ammonium compound is poly(oxyethylene-(dimethyliminio)ethylene (dimethyliminio)ethylenedichloride), which is commercially available under the trademark WSCP from Buckman Laboratories International, Inc.

Ionene polymers have a variety of uses in aqueous systems such as microbicides, bactericides, and algicides as well as controlling, even preventing, biofilm and slime formation. U.S. Pat. Nos. 4,970,211; 4,176,107; 5,382,323; 5,681,862; 4,960,590; 5,637,308; 5,087,457; 5,093,078; and 5,401,881 provide examples of various water-soluble polymers that can benefit from the present invention, and these patents (and all patent and publications mentioned throughout) are incorporated in their entirety by reference herein. These patents further describe commercially-available water-soluble polymer sources, such as from Buckman Laboratories International, Inc.

Ionene polymers may be classified according to the repeating unit found in the polymer. This repeating unit results from the reactants used to make the ionene polymer. A first type of ionene polymer comprises the repeating unit of formula I:

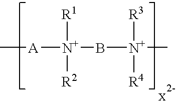

In this formula, R¹, R², R³, and R⁴ can be identical or different, and are selected from H, C₁-C₂₀ alkyl optionally substituted with at least one hydroxyl group, and benzyl optionally substituted on the benzene moiety with at least one C₁-C₂₀ alkyl group. Preferably, R¹, R², R³ and R⁴ are all methyl or ethyl.

The group “A” is a divalent radical selected from C₁-C₁₀ alkyl or alkylene, C₂-C₁₀ alkenyl or alkenylene, C₂-C₁₀ alkynyl or alkynlene, C₁-C₁₀ hydroxyalkyl or hydroxyalkylene, symmetric or asymmetric di-C₁-C₁₀-alkylether, aryl (or arylene), aryl (or arylene)-C₁-C₁₀-alkyl (or alkylene), or C₁-C₁₀-alkylaryl-C₁-C₁₀ alkyl (or C₁-C₁₀ alkylenearyl—C₁-C₁₀ alkylene). “A” can be C₁-C₅ alkyl (or alkylene), C₂-C₅ alkenyl (or alkylene), C₂-C₅ hydroxy-alkyl (or alkylene), or symmetric di-C₂-C₅-alkylether, and most preferably “A” is propylene, 2-hydroxypropylene or diethyleneether. “A” can be a divalent C₁-C₅ alkylene, C₂-C₅ alkenylene, C₂-C₅ hydroxyalkylene, or symmetric di-C₂-C₅-alkylenether, and most preferably “A” is —CH₂CH₂CH₂—, —CH₂CH(OH)CH₂—or —CH₂CH₂OCH₂CH₂—.

The group “B” is a divalent radical selected from C₁-C₁₀ alkylene, C₂-C₁₀ alkenylene, C₂-C₁₀ alkylene, C₁-C₁₀ hydroxyalkylene, arylene, arylene-C₁-C₁₀-alkylene, or C₁-C₁₀-alkylenearyl-C₁-C₁₀-alkylene. Preferably, “B” is C₁-C₅ alkylene, C₂-C₅ alkenylene, C₂-C₅ hydroxyalkylene, arylene, arylene-C₁-C₅-alkylene, or C₁-C₅ alkylenearyl-C₁-C₅-alkylene. Most preferably “B” is —CH₂CH₂—, —CH₂CH₂CH₂—, —CH₂CH₂CH₂CH₂—, —CH₂(CH₂)₃CH₂—, or —CH₂(CH₂)₄CH₂—.

The counter ion, X²⁻, is a divalent counter ion, two monovalent counter ions or a fraction of a polyvalent counter ion sufficient to balance the cationic charge in the repeating unit which forms the ionene polymer backbone. Preferably, X²⁻ is two monovalent anions selected from a halide anion and a trihalide anion and more preferably, chloride or bromide. Ionene polymers having trihalide counter ions are described in U.S. Pat. No. 3,778,476. The disclosure of that patent is incorporated herein by reference.

A second type of ionene polymer comprises the repeating unit of formula II:

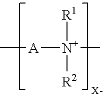

In this formula II, the definitions of R¹, R², and A are the same as those defined above for formula I. X⁻ is a monovalent counter ion, one-half of a divalent counter ion or a fraction of a polyvalent counter ion sufficient to balance the cationic charge of the repeating unit which forms the ionene polymer. X⁻ may be, for example, a halide or trihalide anion and is preferably chloride or bromide.

Among the ionene polymers discussed above, a particularly preferred ionene polymer having a repeating unit of formula I is poly[oxyethylene(dimethyliminio)ethylene(dimethyliminio)ethylene]dichloride. In this ionene polymer, R¹, R², R³ and R⁴ are each methyl, A is —CH₂CH₂OCH₂CH₂—, B is —CH₂CH₂—, and X²⁻ is 2Cl⁻ and the average molecular weight is 1,000-5,000. This ionene polymer is available from Buckman Laboratories, Inc. of Memphis, Tenn. as Busan® 77 product, a 60% aqueous dispersion of the polymer, or WSCP® product, a 60% aqueous dispersion of the polymer. Busan® 77 and WSCP® are biocides used primarily in aqueous systems, including metalworking fluids for microorganism control.

Another particularly preferred ionene polymer having a repeating unit of formula I, also available from Buckman Laboratories, Inc. as Busan® 79 product, or WSCP II product is the ionene polymer where R¹, R², R³ and R⁴ are each methyl, A is —CH₂CH(OH)CH₂—, B is —CH₂CH₂—, and X²⁻ is 2Cl⁻. This ionene polymer is a reaction product of N,N,N′,N′-tetramethyl-1,2-ethanediamine (TMEDA), with (chloromethyl)-oxirane, and has a 1,000-5,000 average molecular weight. The polymer product Busan® 79 or WSCPII product is a 60% aqueous solution of the polymer.

Preferred ionene polymers having the repeating unit of formula II are those where R¹ and R² are each methyl, A is —CH₂CH(OH)CH₂—, and X⁻ is Cl⁻. Busan® 1055 product is a 50% aqueous dispersion of such an ionene polymer obtained as a reaction product of dimethylamine with (chloromethyl)oxirane having a 2,000-10,000 average molecular weight.

Busan® 1157 product is a 50% aqueous dispersion of the ionene polymer having the repeating unit of formula II, obtained as a reaction product of dimethylamine with epichlorohydrin, cross-linked with ethylenediamine, where R¹ and R² are each methyl, A is —CH₂CH(OH)CH₂— and X⁻ is Cl⁻. This ionene polymer has a 100,000-500,000 average molecular weight. Another ionene polymer having the repeating unit of formula II can be obtained as a reaction product of dimethylamine with epichlorohydrin, where R¹ and R² are each methyl, A is —CH₂CH(OH)CH₂—and X⁻ is Cl⁻. This ionene polymer has a 5,000-10,000 average molecular weight, and is available from Buckman Laboratories, Inc. in a 50% aqueous solution as the BUSAN® 1055 product.

Busan® 1155 product is a 50% aqueous dispersion of an ionene polymer having the repeating unit of formula II, where R¹ and R² are each methyl, A is —CH₂CH(OH)CH₂—, X⁻ is Cl⁻ and the ionene polymer is cross-linked with ammonia. This ionene polymer has a molecular weight of approximately 100,000-500,000. Busan® 1155 comprises poly(2-hydroxyethylenedimethyliminio-2-hydroxypropylene-dimethyliminio methylene) dichloride, and is also commercially available as APCA®.

Busan® 1099 product or Bubond® 65 product is a 25% aqueous dispersion of a cross-linked ionene polymer having repeating units of formula II, where R¹ and R² are each methyl, A is —CH₂CH(OH)CH₂—, X⁻ is Cl⁻, the cross-linking agent is monomethylamine. This ionene polymer has a molecular weight of approximately 10,000-100,000.

Each of the above ionene polymers and products identified by trade name is available from Buckman Laboratories, Inc. of Memphis, Tenn.

The first cross-linkable polymer can be prepared by known methods. For example, the ionene polymers having the repeating unit of formula I may be prepared by a number of known methods. One method is to react a diamine of the formula R¹R²N—B—NR¹R² with a dihalide of the formula X-A-X. Ionene polymers having this repeating unit and methods for their preparation are, for example, described in U.S. Pat. Nos. 3,874,870, 3,931,319, 4,025,627, 4,027,020, 4,506,870 and 5,093,078; the disclosures of which are incorporated herein by reference.

The ionene polymers having the repeating unit of formula II may be prepared by known methods. One method is to react an amine of the formula R¹R²NH with a haloepoxide such as epichlorohydrin. Ionene polymers having the repeating unit of formula II are, for example, described in U.S. Pat. Nos. 4,111,679 and 5,051,124, the disclosures of which are incorporated herein by reference.

Ionene polymers comprising the repeating units of formulae I or II may also be cross-linked with primary, secondary or other polyfunctional amines using means known in the art. Ionene polymers can be cross-linked either through the quaternary nitrogen atom or through another functional group attached to the polymer backbone or to a side chain.

Cross-linked ionene polymers, prepared using cross-linking co-reactants, are disclosed in U.S. Pat. No. 3,738,945 and Reissue U.S. Pat. No. 28,808, the disclosures of which are incorporated herein by reference. The Reissue Patent describes the cross-linking of ionene polymers prepared by the reaction of dimethylamine and epichlorohydrin. The cross-linking coreactants listed are ammonia, primary amines, alkylenediamines, polyglycolamines, piperazines, heteroaromatic diamines and aromatic diamines.

U.S. Pat. No. 5,051,124, the disclosure of which is incorporated herein by reference, describes cross-linked ionene polymers resulting from the reaction of dimethylamine, a polyfunctional amine, and epichlorohydrin. Other examples of various cross-linked ionene polymers, their properties, and methods of making thereof, are provided in U.S. Pat. Nos. 3,894,946, 3,894,947, 3,930,877, 4,104,161, 4,164,521, 4,147,627, 4,166,041, 4,606,773, and 4,769,155. The disclosures of each of these patents are incorporated herein by reference.

The ionene polymers comprising the repeating units of formulae I or II may also be capped, i.e., have a specific end group. Capping may be achieved by means known in the art. For example, an excess of either reactant used to make the ionene polymer can be employed to provide a capping group. Alternatively, a calculated quantity of a monofunctional tertiary amine or monofunctional substituted or unsubstituted alkyl halide can be reacted with an ionene polymer to obtain a capped ionene polymer. Ionene polymers can be capped at one or both ends. Capped ionene polymers and their microbicidal properties are described in U.S. Pat. Nos. 3,931,319 and 5,093,078, the disclosures of each of these patents is incorporated herein by reference.

The quaternary ammonium compound may be present in the aqueous system in any effective amount, such as in a range of from about 0.01 ppm to about 1,000 ppm and preferably in the range of from about 0.1 ppm to about 100 ppm.

Preferably, the water solubility of the second cross-linkable polymer is from about 1% to about 100%, such as from 1% to 70%, or from 5% to 50%, or from 10% to 40%, or from 15% to 40%. Preferably, the amount of cross-linking of the second cross-linkable polymer is from about 20% to about 99%. Preferably, the percent weight of the second cross-linking polymer is from about 70% to about 90%. The second cross-linkable polymer can have an average molecular weight of from about 50,000 to about 5,000,000 Daltons, such as 100,000 to 1,000,000 Daltons, or 250,000 to 750,000, 500,000 to 2,000,000, and the like. The second cross-linkable polymer can have a level of deacetylation from about 70% to about 95%. Preferably, the level of deacetylation is from about 75% to about 78%. Other levels of deacetylation can be used.

Examples of suitable second cross-linkable polymers include polysaccharides, including salts or derivatives thereof, such as salts or derivatives of chitosan, such as chitosan acetate, chitosan lactate, chitosan glutamate, methyl-chitosan, N-carboxymethylchitosan, and the like. Preferably, the second cross-linkable polymer includes chitosan.

The second cross-linkable polymer can be a chitosan compound, such as chitosan itself (which is a deacetylated chitin (a naturally occurring biopolymer) that is typically more than about 50% deacetylated), salts of chitosan, chitosan-gel, or mixtures of these. Mixtures of chitosan salt powders with chitosan salt gels have been found to provide good molding and casting properties to the resulting composition.

Chitosan is a polymer that generally does not exhibit substantial expansion or shrinkage when combined with the above polymeric sources and when dried to form a solid. The inclusion of a chitosan salt to a chitosan gel can provide additional chitosan to the cross-linkable matrix while preventing it from getting too wet during manufacture.

Chitosan materials, including chitosan and chitosan salts, are commercially available from companies like Aldrich, Waco, NutriScience, CarboMer, and the like. The molecular weight of chitosans suitable for use in the present invention can be from about 50,000 to about 5,000,000 Daltons (e.g., 100,000 to 5,000,000; 500,000 to 5,000,000; 750,000 to 5,000,000; 1,000,000 to 5,000,000, and the like) and/or the level of deacetylation can be from about 50% to about 98%, preferably from about 75% to about 78%. Other levels of deacetylation can be used.

Optionally, the second cross-linkable polymer is a mixture of a chitosan salt and chitosan gel. The chitosan salt is desirably an easily prepared salt of chitosan, such as a salt of chitosan with a 1 to 18 carbon mono- or poly-carboxylic acid, preferably chitosan acetate or chitosan lactate. Chitosan of any degree of deacetylation available on the market can generally be used. However, chitosans having degrees of deacetylation above 50% are suitable due to their solubility characteristics. Salts of chitosan and lactic acid have been found to be effective as the cross-linkable polymer. The chitosan salt is typically added to the composition as a powder in an amount ranging from about 1% to about 5%, more particularly from about 2% to about 4%, even more particularly from about 2% to about 3%, by weight based on the total composition, and can be mixed with metal ion sources during manufacture of the composition.

The chitosan and similar cross-linkable polymers and the methods of making thereof are described in U.S. Pat. No. 6,217,780, which is incorporated herein in its entirety, and are applicable to the present invention.

A chitosan-gel can be added to the composition after mixing of the chitosan powder with metal ion sources. Chitosan-gel can be prepared by dissolving chitosan powder into a weak acid. Good results have been obtained by dissolving 1 to 10% by wt (e.g., 4% to 8% by wt) chitosan powder into 10% by weight of a weak acid, which may be citric acid, acetic acid, lactic acid, boric acid, or salicylic acid, especially citric acid.

The second cross-linkable polymers suitable for forming the matrix of the compositions according to the present invention can include generally polymers that will solubilize in water relatively slowly (when compared to the first cross-linkable polymer). Desirably, these polymers will not exhibit substantial expansion or shrinkage when combined with the ion sources or other components, and/or when dried to form a solid. When used in a cross-linkable polymer matrix for the composition, the second cross-linkable polymer can serve to clarify water and/or release itself over time. For instance, the second cross-linkable polymer can be formulated for the cross-linkable matrix to slowly be released over a period of time ranging from 1 hour to 7 days, 7 days to 4 to 6 weeks, 4 to 6 weeks to 4 to 6 months, 4 to 6 months to 1 year or more, or 2 to 3 days to 1 year or more than one year. For example, the release rate can be from about a few hours to a few days, a few days to a few weeks, a few weeks to a few months, a few months to more than a year, or a few days to more than a year. Preferably, the release rate is longer than a few days. More preferably, the release rate is a few days to a few weeks. The release rate of the second cross-linkable polymer is preferably at least slower than the release rate of the first cross-linkable polymer.

The presence of at least one less water soluble polymer or slow release material such as the second cross-linkable polymer can further enhance the antimicrobial activity when used with another biocidal component. For instance, the second cross-linkable polymer can enhance the anti-algal activity of the compositions according to the present invention, or of other different compositions. In one or more embodiments, the second cross-linkable polymer can be a biocidal agent. The biocidal agent can be at least one microbicide, at least one bactericide, and/or at least one algicide. Preferably, the biocidal agent is at least one algicide. If the second cross-linkable polymer is a biocidal agent, it can be used as a biocidal component alone for the composition according to the present invention. Preferably, the second cross-linkable polymer is used in combination with other polymers and/or biocidal agents/components.

One of ordinary skill can readily determine the effective amount of the second cross-linkable polymer, when it is a biocidal agent that is useful for a particular application, by simply testing various concentrations prior to treatment of an entire affected system. For instance, in an aqueous system to be treated, the concentration of the second cross-linkable polymer that is a biocidal agent may be any effective amount, such as from about 0.01 ppm to about 5,000 ppm, and when treating algae, a preferred range is from about 0.01 ppm to about 2,000 ppm, and is preferably in a range of from about 0.1 to about 500 ppm.

The cross-linking agent can be any compound that can cross-link the first cross-linkable polymer and/or the second cross-linkable polymer. Preferably, the cross-linking agent is one that provides a desirable amount of cross-linking so that the first cross-linkable polymer and/or the second cross-linkable polymer is disintegrated or released at a desirable rate as described previously.

Preferably, the average molecular weight of the cross-linking agent is from about 20 to about 800 Daltons. The cross-linking agent can be present in any amount, such as from about 0.1 to about 50 wt %, based on the total weight of the composition.

The cross-linking agent can be at least one base, at least one sulfate ion or sulfuric acid, at least one organic solvent, at least one multifunctional compound. Examples include, but are not limited to, ethoxylated trimethylol propane triacrylate or bis-acrylamide, or combinations thereof. Preferably, the base is an alkali metal hydroxide and/or an alkyl amine. Optionally, the alkali metal hydroxide is sodium hydroxide and/or potassium hydroxide. Preferably, the alkyl amine is triethylamine.

According to an embodiment, the cross-linking agent is at least one organic solvent. Optionally, the organic solvent is methanol, ethanol, isopropanol, acetone, dimethylsulfoxide, glutaraldehyde, glyoxal, epichlorohydrin, succinaldehyde, 1,10-decanedial, trichlorotriazine, benzoquinone, bisephoxirane, or combinations thereof.

In another embodiment, the cross-linking agent comprises at least one multi-functional compound. Preferably, the multi-functional compound comprises a polyaldehyde.

The cross-linking agents that can be used according to the present invention can be typical cross-linking agents for cross-linkable polymers of the composition, such as for the chitosan. For example, after formation of the chitosan matrix, a treatment with a cross-linking agent would follow to modify the physical properties of the chitosan matrix, particularly the solubility thereof in aqueous solvents and the release properties on use.

The treatment can comprise immersing the matrix in the cross-linking agent. If the cross-linking agent is a base, a wide variety of bases can be used including, but not limited to, alkali metal hydroxides, such as sodium and potassium hydroxide, ammonium hydroxide, and alkyl amines, such as triethylamine. Common organic solvents can be used as cross-linking agents, and can be, but not limited to, methanol, ethanol, isopropanol, acetone, dimethylsulfoxide, glutaraldehdyde, glyoxal, epichlorohydrin, succinaldehyde, 1,10-decanedial, trichlorotriazine, benzoquinone, and bisepoxiranes. Multi-functional compounds such as polyaldehydes and mixtures of cross-linking agents can be used as well. The higher the concentration of the agent and the longer the treatment results in a slower release of the cross-linkable polymers, components entrapped within the cross-linkable matrix such as the biocidal component, and/or polymeric algicides that are used (making it less water soluble and therefore a slower release rate).

The cross-linking agent that is used can depend upon the nature of the cross-linkable polymer used. For example, when a chitosan polymer is used as described above, sulfuric acid can be employed in the composition as the cross-linking agent, and is typically added in an amount ranging from about 0.02% to about 0.05% by weight, based upon the total composition. The amount of cross-linking of the first cross-linkable polymer can be from about 1:n−1 to about n−1:1 (where n represents the number of active groups in the crosslinking agent), and the amount of cross-linking of the second cross-linkable polymer is from about 1:n−1 to about n-1:1.

The sulfuric acid aids the cross-linking of the chitosan and helps to solidify the composition. While not wishing to be bound by any theory, it is believed that cross-linking sulfate anions originating from sulfuric acid and sulfate salt sources make bridges between amino groups of chitosan polymeric chains. Carboxyl methyl-chitosan can be cross-linked with glutamic or aspartic acids or salts thereof. These and other known cross-linking agents can be used, such as those described in U.S. Pat. No. 6,217,780, which is incorporated herein in its entirety.

As an option one or more biocidal components (separate from the first and second cross-linkable polymers) can be used in the compositions according to the present invention. Preferably, the biocidal components can be easily entrapped in and/or carried by the first cross-linkable polymer and/or by the second cross-linkable polymer. Desirably, the biocidal components can have properties such that they are released at a desirable rate as, for example, that of the rate of release of the first cross-linkable polymer and/or the second cross-linkable polymer, as previously described. For example, the release rate can be from about 1 hour to 7 days, 7 days to 4 to 6 weeks, 4 to 6 weeks to 4 to 6 months, 4 to 6 months to 1 year or more, or 2 to 3 days to 1 year or more than one year. Preferably, the release rate is no longer than a few days. More preferably, the release rate is a few days to a few weeks. The release rate of the biocidal component is preferably at least slower than the release rate of the first cross-linkable polymer.

The biocidal component can be any composition or element, such as a microbicide, a bactericide, and/or an algicide. The biocidal component can be a lysozyme and/or other enzymes, such as protenase or cutinase. The biocidal component, if present, is different from the first or second cross-linkable polymer as previously described. The biocidal component can be metal ions, such as zinc, silver, copper, or combinations thereof. These components can be in any form, such as nano-sized particles, such as, nanosilver particles. Optionally, the biocidal component comprises an algicide and/or silver. Preferably, the biocidal component is nanosilver particles. The biocidal component can be in a liquid form, a gel form or a solid form.

Preferably, the weight percent of the biocidal component is from about 0.01% to about 10%, by weight, based on the weight of the composition. However, any amount of biocidal component can be used to treat water or other systems. For example, the biocidal component may be present in the system in any effective amount, such as in a range of from about 0.01 ppm to about 1,000 ppm and preferably in the range of from about 0.1 ppm to about 100 ppm.

According to one or more embodiments, the composition(s) is formulated to slowly release the biocidal component and/or the second cross-linkable polymer, as compared to the first cross-linkable polymer. The release rate can be as previously described for the first cross-linkable polymer, the second cross-linkable polymer, and/or the biocidal component.

In another embodiment, the composition is formulated to rapidly release the biocidal component and to slowly release the second cross-linkable polymer, as compared to the first cross-linkable polymer. The release rate can be as previously described for the first cross-linkable polymer, the second cross-linkable polymer, and/or the biocidal component.

In an embodiment, the composition does not substantially expand or shrink when the first cross-linkable polymer is combined with the biocidal component, the second cross-linkable polymer, and/or the cross-linking agent, or when in a dried solid form.

In another embodiment, the cross-linking agent modifies the solubility of the cross-linkable matrix in aqueous solvents and modifies the release properties of the composition.

The concentrations of biocidal component and quaternary ammonium compound (or other active ingredient) as described above or as described elsewhere in this application, may be the initial concentrations of the components at the time that the components are combined or added to an aqueous system and/or may be the concentrations of the components at any time after the components have interacted with the aqueous system.

The compositions according to the present invention can be prepared by any methods known to one skilled in the art. The amount of the components can be used based on the desired properties as previously described. The methods of making the compositions can be modified in order to provide the desired properties, such as the amount of cross-linking and release rate. The individual components can be prepared by any methods as previously described and as indicated below.

For example, a method that can be used to prepare the second cross-linkable polymer, such as the chitosan gel, is to dissolve the chitosan in any one of a large number of weak acids including organic acids, such as, but not limited to, formic, acetic, citric, pyruvic, lactic, glycolic, or malic acid. Good results have been obtained by dissolving 1:1 (w/w) chitosan powder into citric acid. A chitosan gel can readily act as a binder which permits the composition to solidify and be easily extruded and/or formed into a variety of shapes.

These polymers and the biocidal components can be combined with the cross-linkable matrix by known methods, such as described in U.S. Pat. No. 6,217,780, which is incorporated herein in its entirety.

In another aspect of the present invention, methods of using the compositions according to the present invention are provided, wherein the compositions are used to control (kill, prevent or inhibit growth) algae. The composition can be used to treat water or other systems, such as a swimming pool, a spa, a water-feature, a lake, a pond, a cooling tower, fields, hydroponics, agricultural uses, such as rice fields or other wet fields, or combinations thereof.

The present invention is particularly suitable for aqueous water systems or other systems that come into contact with higher organisms, which are not harmed by the composition of the present invention because of its low toxicity. Therefore, the present invention may be used, for example, for controlling microorganisms, e.g., algae, in, for example, swimming pools, spas and hot tubs and for controlling algae in water systems used in aquaculture, including fish hatcheries, fish farms, shrimp ponds, crawfish ponds, mollusk, and the like, or agricultural uses, or hydroponics.

Examples of the microorganisms that are controlled include fungi, bacteria, algae, and mixtures thereof, such as, but not limited to, for example, Trichoderma viride, Aspergillus niger, and Chlorella sp. A further example is a gram-positive microorganism, like Bacillus species. The compositions of the present invention are effective in controlling mustard algae or black algae.

As an example, the compositions according to the present invention can be added to a saline water system, such as a water system using a saline chlorination system. For example, the water system may contain from about 2,000 ppm to about 8,000 ppm, such as 2,800 ppm to 6,000 ppm, of sodium chloride. The composition according to the present invention can optionally act synergistically with sodium chloride to provide a composition to control the growth of microorganisms, particularly algae. Because of the activity of the inventive composition to control algae and/or other microorganisms, there may be a reduced need to run the chlorine generator in such a water system, thereby reducing electrical costs and reducing the likelihood of undesirable effects from over-chlorination.

The compositions of the present invention may be added to control algae and other microorganisms in an aqueous system that has been treated for reduction or removal of chlorine. For example, aquariums may contain plant and animal species that are sensitive to chlorine, even in the amount that is present in common municipal water sources, so that the water used therein must be filtered or treated for the removal of chlorine. The compositions can then supply at least some of the microorganism-controlling activity that is lost by the reduction or removal of chlorine.

The method of using the compositions according to the present invention may be practiced at any pH, such as a pH range of from about 2 to about 11, with a preferable pH range of from about 5 to about 9. For an aqueous system that will be in contact with higher organisms, such as humans or fish, the pH should be neutral (around pH 7). The pH of the aqueous system may be adjusted by adding an acid(s) or a base(s) as is known in the art. The acid or base added should be selected to not react with any components in the system. However, it is preferable to add the biocidal component and optional quaternary ammonium compound to water without pH adjustment.

The compositions according to the present invention may be used in any industrial, agricultural, or recreational aqueous systems or other system requiring microorganism control. Such aqueous systems include, but are not limited to, hydroponics, wet fields, marshes, rice patties, metal working fluids, cooling water systems (cooling towers, intake cooling waters and effluent cooling waters), waste water systems including waste waters or sanitation waters undergoing treatment of the waste in the water, e.g. sewage treatment, recirculating water systems, swimming pools, hot tubs, food processing systems, drinking water systems, leather-processing water systems, white water systems, pulp slurries and other paper-making or paper-processing water systems. In general, any industrial, agricultural, or recreational water system can benefit from the present invention. The compositions may also be used in the treatment of intake water for such various industrial processes or recreational facilities. Intake water can be first treated by the method of the present invention so that the microbial growth is inhibited before the intake water enters the industrial process or recreational facility.

The present invention will be further clarified by the following examples, which are intended to be exemplary of the present invention.

### EXAMPLES

### Example 1

Chitosan gel was prepared by thoroughly mixing 2.0 g of chitosan powder (Aldrich, high molecular weight) in 50 ml of a 10% citric acid solution and heated slightly until dissolved. 6.0 g of this gel was mixed with 2.0 g of chitosan lactate to form a paste before adding 3.2 g of Busan® 77 product (a 60% aqueous dispersion of the ionene polymer or polymeric quaternary ammonium compound, available from Buckman Laboratories, Inc. of Memphis Tenn., as previous described), and 1.0 g of 25% water solution of sulfuric acid. The paste was mixed thoroughly and left to dry overnight at 40° C. The product solidified into a rigid mass that neither shrank nor expanded during solidification.

### Example 2

Chitosan gel was prepared by thoroughly mixing 2.0 g of chitosan powder (Aldrich, high molecular weight) in 50 ml of a 10% citric acid solution and heated slightly until dissolved. 6.0 g of this gel was mixed with 3.2 g of Busan® 77 product (a 60% aqueous dispersion of the ionene polymer or polymeric quaternary ammonium compound, available from Buckman Laboratories, Inc. of Memphis Tenn., as previously described), and 1.0 g of 25% water solution of glutaraldehyde. The paste was mixed thoroughly and left to dry overnight at 40° C. The product solidified into a rigid mass that neither shrank nor expanded during solidification.

### Example 3

The effectiveness of a slow release algaecidal composition was evaluated. Chitosan gel was prepared by thoroughly mixing 2.0 g of chitosan powder (Aldrich, high molecular weight) in 50 ml of a 10% citric acid solution and heated slightly until dissolved. 6.0 g of this gel was mixed with 2.0 g of chitosan lactate to form a paste before adding 3.2 g of WSCP® product (a 60% aqueous dispersion of the ionene polymer or polymeric quaternary ammonium compound, available from Buckman Laboratories, Inc. of Memphis Tenn., as previous described), and 1.0 g of 25% water solution of sulfuric acid. The paste was mixed thoroughly and left to dry overnight at 40° C. The product solidified into a rigid mass that neither shrank nor expanded during solidification.

The effect on Chlorella sp. of this slow release formulation containing 15.8% of active ingredient (a.i.) WSCP®, was tested for 5 weeks. The test was set up in 250 ml flasks containing 50 ml of synthetic cooling water #1. There were 3 treatments: 5,000 ppm a.i. WSCP®, 5,000 ppm product of the slow release formulation for weekly sampling and testing, and 5,000 ppm product of the slow release formula for weekly release evaluation. The synthetic cooling water of the last treatment was changed every week.

0.25 g of slow release material required to provide a 5,000 ppm product was placed in a cheesecloth bag and deposited in the flask with the synthetic cooling water. An empty cheesecloth bag was also placed in the flask containing 5,000 ppm a.i. WSCP® biocide in synthetic cooling water. The beakers with the treatments were placed in a Slow Speed Roto Mix® (Barnstead/Thermolyne) at 60 rpm.

A 1 ml sample from each treatment was taken every week to test its effect against algae The evaluation of algicidal activity was performed using test tubes. The testing conditions were as follows:

Medium: Allen's medium modified
Amount of medium per test tube: 5 ml
Inoculum: 100 microliters/test tube of a Chlorella sp. suspension with 82%
transmittance at 590 nm
Dosages tested from each sample: 0.1, 0.5, 1.0, 5.0, 10.0, 50.0, and
100.0 ppm
Incubation period: 2 weeks
Incubation temperature: 24° C.
Illumination during incubation: 16 h of light and 8 h of darkness

The results from this evaluation are shown in the table below. MIC values represents the Minimum Inhibitory Concentration, defined as the lowest level of compound required to completely inhibit (repress) the growth of a given organism.

| | MIC for | MIC for |
|---|---|---|
| | slow release | control |
| Sampling period | formulation | WSCP ® |
| (week) | (ppm product) | (ppm a.i.) |
| 1 | >0.5 <1 | >0.5 <1 |
| 2 | >0.5 <1 | >0.5 <1 |
| 3 | 1 | 1 |
| 5 | 1 | 1 |

The results show that the slow release formulation containing 15.8% of active ingredient (a.i.) WSCP® performed equally as well as compared to the control, which is a formulation only containing WSCP® for controlling Chlorella sp. The MIC values (the Minimum Inhibitory Concentration values), which are the lowest level of compound required to completely inhibit (repress) the growth of Chlorella sp. was the same for both formulations. The results show good values of MIC for both formulations, and therefore, the formulations are effective for controlling Chlorella sp.

### Example 4

The effectiveness of two slow release algicidal compositions was evaluated. The two slow release formulations contain 2.54% of active ingredient WSCP® product and APCA® product, respectively. The WSCP® product is a 60% aqueous dispersion of the ionene polymer, similar to the Busan® 77 product, available from Buckman Laboratories, Inc. of Memphis, Tenn., as previously described. The APCA® product comprises poly(2-hydroxyethylenedimethyliminio-2-hydroxypropylene-dimethyliminio methylene)dichloride, an ionene polymer, which is also commercially available and is similar to Busan® 1055, as described above

Chitosan gel was prepared by thoroughly mixing 2.0 g of chitosan powder (Aldrich, high molecular weight) in 50 ml of a 10% citric acid solution and heated slightly until dissolved. 6.0 g of this gel was mixed with 2.0 g of chitosan lactate to form a paste before adding 0.8 g of active ingredient WSCP® product or APCA® product, and 1.0 g of 25% water solution of sulfuric acid. The paste was mixed thoroughly and left to dry overnight at 40° C. The product solidified into a rigid mass that neither shrank nor expanded during solidification.

The effect on Chlorella sp. of the two slow release formulations containing 2.54% a.i. WSCP® product or APCA® product were tested using standard methods for screening algicidal materials and under conditions similar to EXAMPLE 3 as described above. The formulations were tested for an incubation period of 2 weeks.

The results from this evaluation are shown in the table below. MIC values represents the Minimum Inhibitory Concentration, defined as the lowest level of compound required to completely inhibit (repress) the growth of a given organism.

| | MIC |
|---|---|
| Material Tested | (ppm product) |
| WSCP ® formulation | >0.1 <0.3 |
| APCA ® formulation | >0.1 <0.3 |

The results show that the slow release formulation containing 2.54% of active ingredient (a.i.) WSCP® product performed equally as well as compared to the slow release formulation containing 2.54% of active ingredient (a.i.) APCA® product, for controlling Chlorella sp. The MIC values (the Minimum Inhibitory Concentration values), which are the lowest level of compound required to completely inhibit (repress) the growth of Chlorella sp. was the same for both formulations. The results show good values of MIC for both formulations, and therefore, the formulations are effective for controlling Chlorella sp.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A composition comprising:
a cross-linkable matrix comprising at least one first cross-linkable polymer, at least one second cross-linkable polymer, and at least one cross-linking agent, wherein said first cross-linkable polymer has a higher water solubility than said second cross-linkable polymer.

2. The composition of claim 1, further comprising at least one biocidal component, wherein the biocidal component is different than the first and second cross-linkable polymer.

3. The composition of claim 2, wherein the biocidal component is an algicide.

4. The composition of claim 2, wherein the first cross-linkable polymer is an algicide.

5. The composition of claim 1, wherein the first cross-linkable polymer is a biocidal agent.

6. The composition of claim 2, wherein the composition is formulated to slowly release the biocidal component and/or the second cross-linkable polymer over a period of at least 2 weeks.

7. The composition of claim 2, wherein the composition is formulated to rapidly release the biocidal component and to slowly release the second cross-linkable polymer.

8. The composition of claim 2, wherein the biocidal component is a metal ion, an enzyme, or any combination thereof.

9. The composition of claim 2, wherein the biocidal component is silver, copper, or zinc.

10. The composition of claim 2, wherein the biocidal component comprises silver or ions thereof.

11. The composition of claim 1, wherein the second cross-linkable polymer comprises chitosan, a chitosan derivative, a chitosan salt, a chitosan gel, a polysaccharide, or combinations thereof.

12. The composition of claim 11, wherein the second cross-linkable polymer comprises chitosan.

13. The composition of claim 12, wherein the chitosan has an average molecular weight of from about 50,000 to about 5,000,000 Daltons.

14. The composition of claim 12, wherein the chitosan has a level of deacetylation from about 30% to about 95%.

15. The composition of claim 14, wherein the chitosan has a level of deacetylation from about 75% to about 78%.

16. The composition of claim 2, wherein the composition does not substantially expand or shrink when the first cross-linkable polymer is combined with the biocidal component, the second cross-linkable polymer, and/or the cross-linking agent, or when in a dried solid form.

17. The composition of claim 1, wherein the cross-linking agent is at least one base, at least one sulfate ion or sulfuric acid, at least one organic solvent, at least one multifunctional compound, or any combination thereof.

18. The composition of claim 17, wherein the base is an alkali metal hydroxide and/or an alkyl amine.

19. The composition of claim 18, wherein the alkali metal hydroxide is sodium hydroxide and/or potassium hydroxide.

20. The composition of claim 18, wherein the alkyl amine is triethylamine.

21. The composition of claim 1, wherein the cross-linking agent is at least one organic solvent.

22. The composition of claim 21, wherein the organic solvent is methanol, ethanol, isopropanol, acetone, dimethylsulfoxide, glutaraldehyde, glyoxal, epichlorohydrin, succinaldehyde, 1,10-decanedial, trichlorotriazine, benzoquinone, bisephoxirane, or combinations thereof.

23. The composition of claim 1, wherein the cross-linking agent comprises at least one multi-functional compound.

24. The composition of claim 23, wherein the multi-functional compound comprises a polyaldehyde.

25. The composition of claim 1, wherein the first cross-linking polymer comprises an ionene polymer or a polymeric quaternary ammonium compound.

26. The composition of claim 1, wherein the water solubility of the first cross-linkable polymer is from about 60 to about 100%, and the water solubility of the second cross-linkable polymer is from about 1% to about 40%.

27. The composition of claim 1, wherein the amount of cross-linking of the first cross-linkable polymer is from about 1:n−1 to about n-1:1, where n represents the number of active groups in the crosslinking agent, and the amount of cross-linking of the second cross-linkable polymer is from about 1:n−1 to about n−1:1.

28. The composition of claim 1, wherein the first cross-linkable polymer is present in an amount of from about 1% to about 80%, the second cross-linkable polymer is present in an amount of from about 15% to about 98%, and the cross-linking agent is present in an amount of from about 0.1% to about 5%, based on the weight of the composition.

29. The composition of claim 2, wherein the first cross-linkable polymer is present in an amount of from about 1% to about 80%, the second cross-linkable polymer is present in an amount of from about 15% to about 98%, the cross-linking agent is present in an amount of from about 1% to about 5%, and the biocidal component is present in an amount of from about 0.01% to about 10%, based on the weight of the composition.

30. A method to control algae in a water source comprising controlling said algae with an effective amount of the composition of claim 1.

31. The method of claim 30, wherein said water source is a swimming pool, a spa, a water-feature, a lake, a pond, a cooling tower, or combinations thereof.
